(19) United States
(12) Patent Application Publication
(10) Pub. No.: US 2007/0211196 A1
(43) Pub. Date: Sep. 13, 2007

(54) Color filter panel and manufacturing method thereof

(75) Inventors: Min Kang, Seoul (KR); Byoung-Joo Kim, Anyang-si (KR); Chul Huh, Suwon-si (KR); Sang-Hun Lee, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/709,524

(22) Filed: Feb. 21, 2007

(30) Foreign Application Priority Data
Feb. 21, 2006 (KR) 10-2006-0016704

(51) Int. Cl. G02F 1/1335; G02F 1/1339

(52) U.S. Cl. 349/106; 349/156

(57) ABSTRACT

A color filter panel for a flat panel display includes a substrate, a plurality of color filters formed on the substrate and dyed by at least two color dyes to represent at least two colors, and a column spacer made of the same material as the color filters.

### CROSS-REFERENCE TO RELATED APPLICATION

This application claims priority to and the benefit of Korean Patent Application No. 10-2006-0016704 filed in the Korean Intellectual Property Office on Feb. 21, 2006, the entire contents of which are incorporated herein by reference.

### BACKGROUND OF THE INVENTION

1. Field of the Invention

The present invention relates to a color filter panel and a method of manufacturing the color filter panel.

2. Discussion of Related Art

Liquid crystal displays (LCDs) are widely-used flat panel displays that include a pair of panels including field generating electrodes, such as pixel electrodes and a common electrode, and a liquid crystal (LC) layer disposed between the pair of panels. Since voltages are applied to the field generating electrodes to determine the orientations of the LC molecules in the LC layer and the molecular orientations determine the transmittance of light passing through the LC layer, the light transmittance can be varied by controlling the applied voltages.

In the LCDs, the pixel electrodes are formed on one panel in a matrix, and the common electrode is formed on the entire surface of the other panel.

For color display in the LCDs, color filters that represent one of the primary colors such as red, green, and blue are formed on one of the two panels. The color filters are manufactured by pigment dispersing, etc.

### SUMMARY OF THE INVENTION

According to one aspect of the present invention, an exemplary embodiment provides a color filter panel having a substrate, a plurality of color filters formed on the substrate and dyed by at least two color dyes to represent at least two colors, and a column spacer made of the same material as the color filters.

The color filter panel may further include a black matrix formed between the color filters representing the different colors from each other and repeatedly dyed by the two color dyes.

The color filters may be dyed using an inkjet method or a dipping method.

The column spacer may be repeatedly dyed by the two color dyes.

Another embodiment of the present invention provides a color filter panel, which includes a substrate, a plurality of sidewalls formed on the substrate, a plurality of black matrixes formed between the sidewalls, and a plurality of color filters formed between the black matrixes and dyed by at least two color dyes to represent at least two colors.

The color filter panel may further include a column spacer between the sidewalls.

The column spacer may be made of the same material as the color filters.

The column spacer may be repeatedly dyed by the two color dyes.

The black matrixes may be repeatedly dyed by the two color dyes.

The color filters may be dyed using an inkjet method.

The sidewalls may be narrower than the black matrixes.

Yet another embodiment of the present invention provides a manufacturing method of a color filter panel, which includes forming a first photoresist film on a substrate, patterning the first photoresist film to form a plurality of first color filter regions, dyeing the first color filter regions with a first dye, forming a second photoresist film on the substrate and the first color filter regions, patterning the second photoresist film to form a plurality of second filter regions, dyeing the second color filter regions with a second dye, forming a second photoresist film on the substrate and the first color filter regions, patterning the second photoresist film to form a plurality of second color filter regions, forming a first protection layer on portions of the first color filter regions, dyeing the second color filter regions and black matrix portions not covered with the first protection layer with a second dye, forming a third photoresist film on the substrate, the first and second color filter regions, and the first protection layer, patterning the third photoresist film to form a plurality of third color filter regions, forming a second protection layer on portions of the second color filter regions, and dyeing the third color filter regions and the black matrix portions with a third dye.

The formation of the first color filter regions may include forming a column spacer.

The color filter regions and the column spacer are formed using an optical mask having a translucent area.

The first to third dyes may have different colors from each other, and the colors may be red, green, and blue.

The black matrix portions may function as black matrixes.

The manufacturing method may further include removing a portion of the column spacer.

Yet another embodiment of the present invention provides a manufacturing method of a color filter panel, which includes forming a black matrix having a plurality of openings, forming a photoresist film on the black matrix, patterning the photoresist film to form a plurality of color filter patterns, and dyeing the color filter patterns with a predetermined color.

The color filter patterns may be formed on substantially the same positions as the openings.

The color filter patterns may be dyed with one of a plurality of colors.

The plurality of colors may be red, green, and blue.

The color filter patterns may be dyed by injection of inks.

The inks may be injected until the ink deposition thickness on the color filter patterns is about 0.5 μm to 1.5 μm.

Another embodiment of the present invention provides a method of manufacturing a color filter panel which includes forming a plurality of sidewalls on a substrate, forming a photoresist film on the substrate, patterning the photoresist film to form a plurality of color filter regions and a plurality of black matrix regions, and dyeing the color filter regions and the black matrix regions with a predetermined color to form a plurality of color filters and a plurality of black matrixes.

The color filter regions may have first to third regions.

The first to third regions may be dyed with different colors.

The first to third regions may be dyed with one of red, green, and blue.

The black matrix regions may be dyed with red, green, and blue.

The black matrix regions may be formed between the sidewalls.

The formation of the color filter regions and the black matrix regions may include forming a column spacer.

The column spacer may be formed between the sidewalls.

The sidewalls may be narrower than the black matrixes.

### BRIEF DESCRIPTION OF THE DRAWINGS

The present invention will become more apparent by describing preferred embodiments thereof in detail with reference to the accompanying drawings, in which:

FIGS. 1A to FIG. 1J are drawings sequentially showing manufacturing processes of a color filter panel according to a first exemplary embodiment of the present invention;

FIGS. 2A to FIG. 2E are drawings sequentially showing manufacturing processes of a color filter panel according to a second exemplary embodiment of the present invention;

FIGS. 3A to FIG. 3E are drawings sequentially showing manufacturing processes of a color filter panel according to a third exemplary embodiment of the present invention;

FIG. 4 is a layout view of the color filter panel according to the first embodiment of the present invention;

FIG. 5 is a sectional view of the color filter panel shown in FIG. 4 taken along the line IV-IV.

### DETAILED DESCRIPTION OF THE EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Color filter panels according to exemplary embodiments of the present invention will now be described with reference to drawings.

### First Exemplary Embodiment

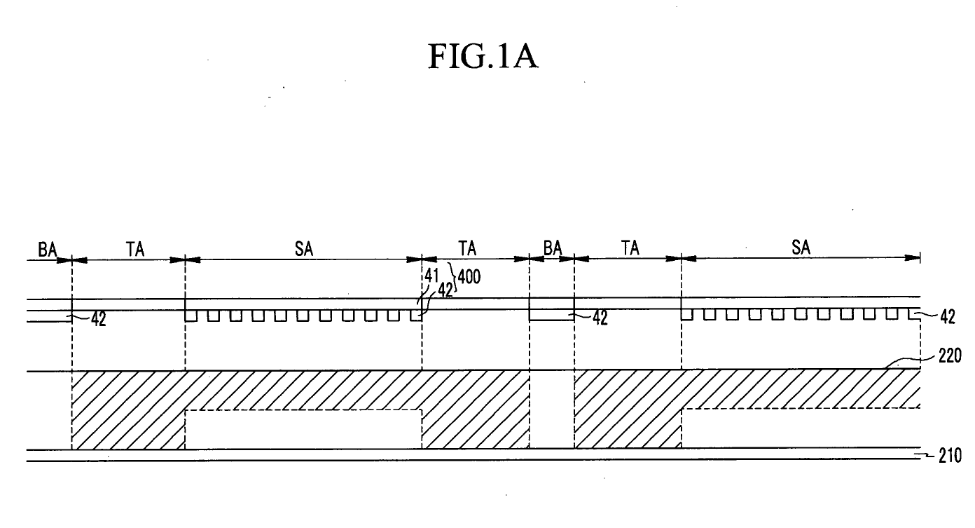

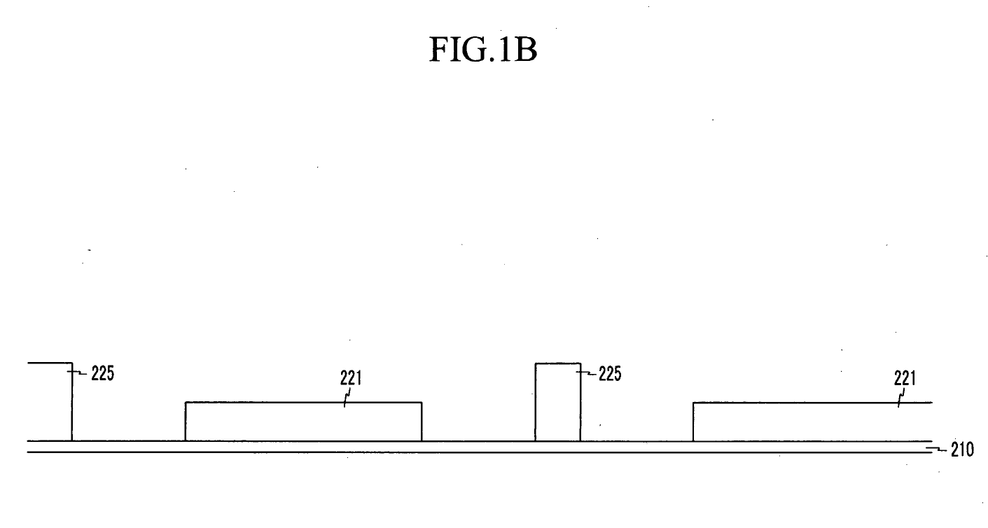

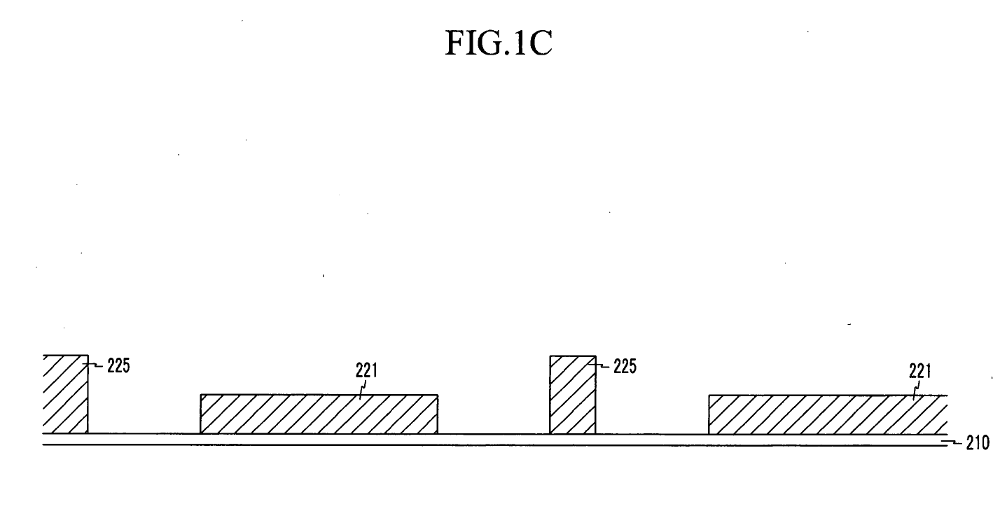

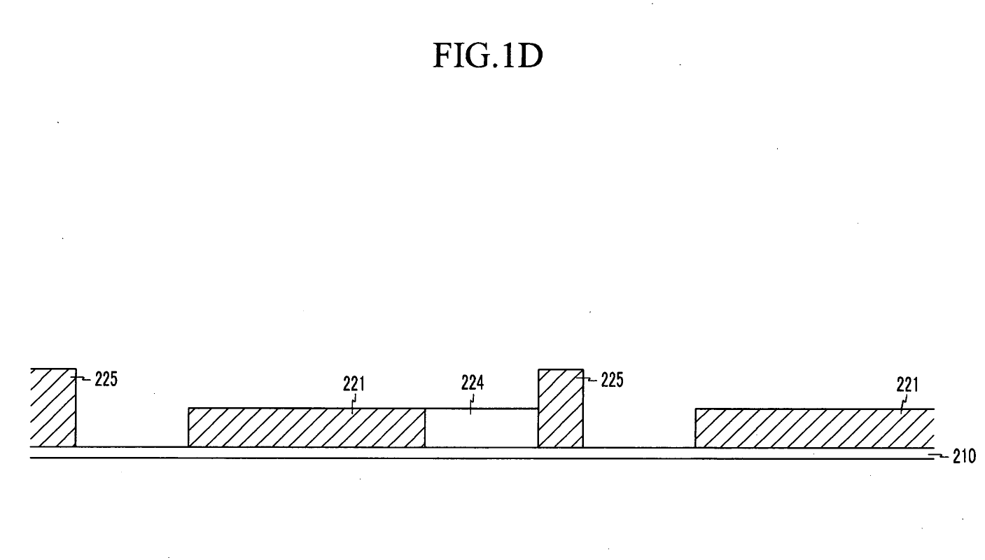

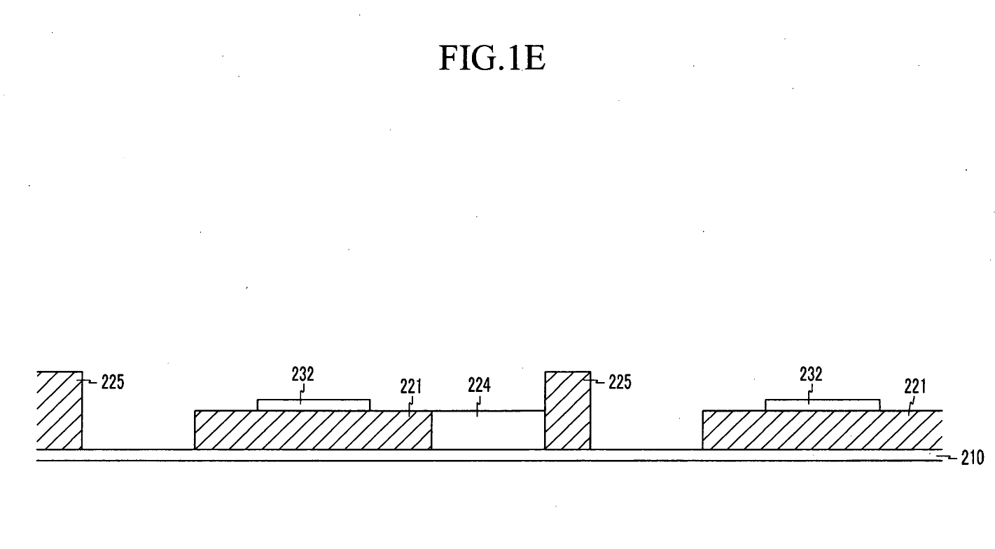

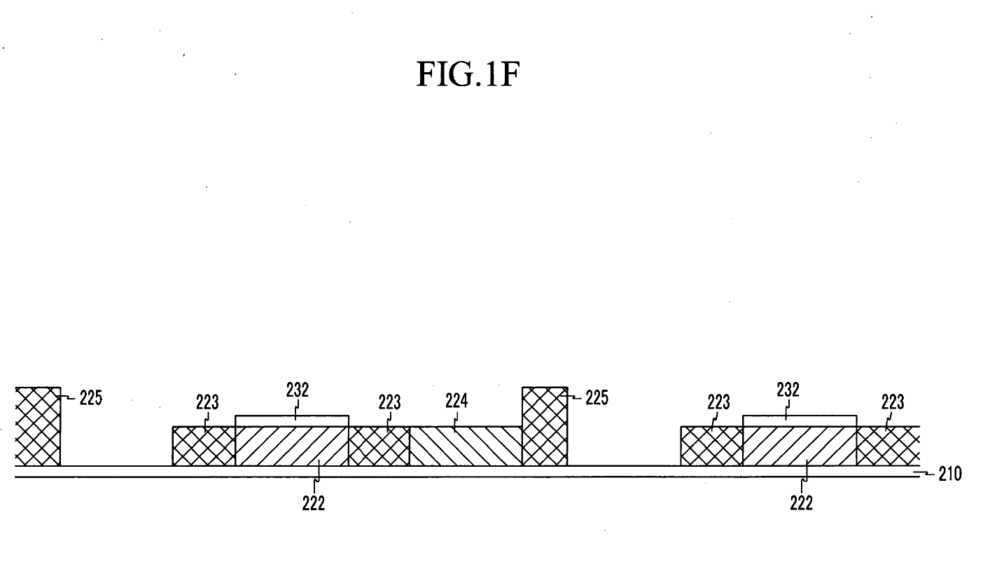

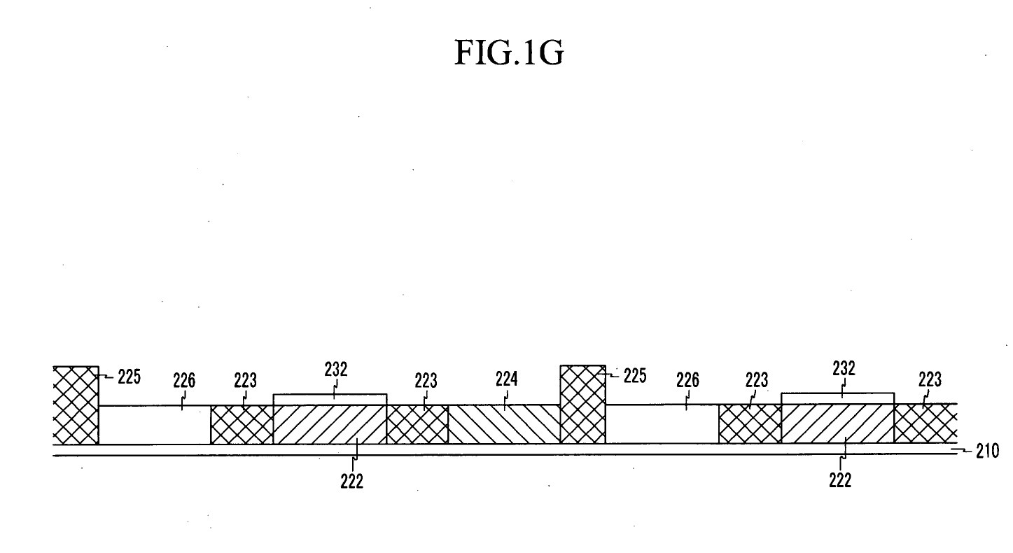

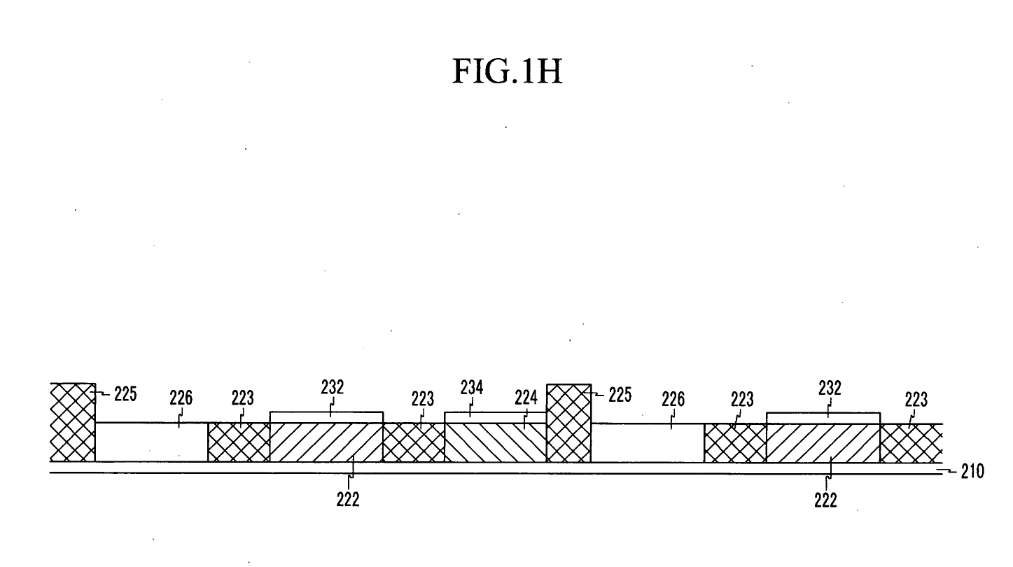

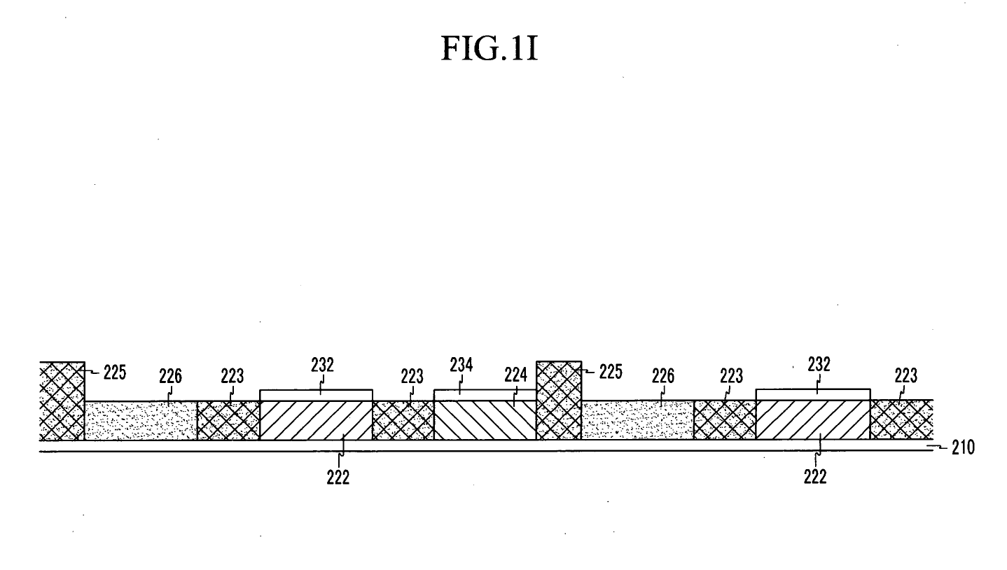

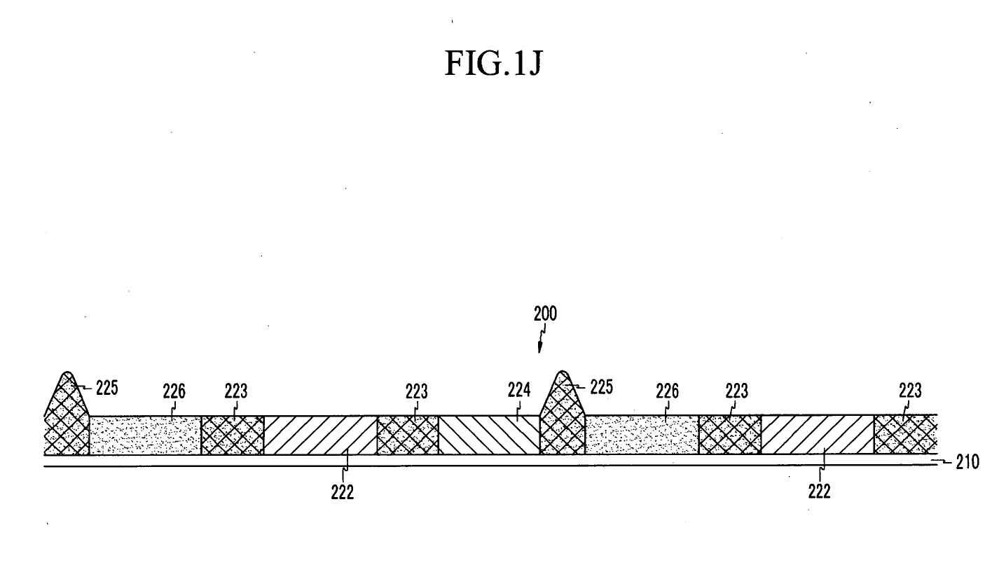

A first exemplary embodiment of the present invention will be described with reference to FIGS. 1A to 1J.

FIGS. 1A to FIG. 1J are drawings sequentially showing manufacturing processes of a color filter panel according to a first exemplary embodiment of the present invention.

As shown in FIG. 1A, a photoresist film 220 is applied on an insulating substrate 210. The photoresist film 220 may be made of a photosensitive resin material and be dyed. The photoresist film 220 is exposed to light through an optical mask 400 and is developed to form photoresist patterns 221 (referred to as “red photoresist patterns”) for red and column spacers 225.

As shown in FIG. 1A, the optical mask 400 includes a transparent substrate 41 and an opaque light blocking film 42, and it is divided into light transmitting areas TA, light blocking areas BA, and translucent areas SA. The light blocking film 42 is not disposed on the light transmitting areas TA, but it is disposed on the light blocking areas BA and the translucent areas SA. The light blocking film 42 exists as a wide area having a larger width than a predetermined value on the light blocking areas BA, and it exists as a plurality of areas having smaller width or distance than a predetermined value to form slits.

The translucent areas SA may have a slit pattern or a lattice pattern, or they may be a thin film(s) with intermediate transmittance or intermediate thickness.

In an exemplary embodiment, the photoresist film 220 is a positive photoresist film. Thus, when the photoresist film 220 is exposed and developed, portions of the photoresist film 220 that receive a predetermined amount of light are removed.

Referring to FIG. 1A, portions of the photoresist film 220 facing the light transmitting areas TA are removed, portions of the photoresist film 220 facing the translucent areas SA come to have a reduced thickness such that the red photoresist patterns 221 are formed, and portions of the photoresist film 220 facing the light blocking areas BA remain such that the column spacers 225 are formed. In the figures, the hatched portions indicate the portions of the photoresist that are removed after development.

However, alternatively, the photoresist film 220 may be a negative photoresist film. In this case, compared to the positive photoresist film, the portions of the photoresist film 220 facing the light transmitting areas TA remain and the portions of the photoresist film 220 facing the light blocking areas BA are removed. However, the portions of the photoresist film 220 facing the light translucent areas SA come to have a reduced thickness as with the positive photoresist film.

As shown in FIG. 1C, the substrate 210 having the column spacers 225 and the red photoresist patterns 221 is dipped into a red dye, such that the column spacers 225 and the red photoresist patterns 221 are dyed in a red color, to form red color filter patterns.

Next, as shown in FIG. 1D, after a photoresist film (not shown) is applied on the column spacers 225, the red photoresist patterns 225, and the exposed substrate 210, the photoresist film is exposed to light through an optical mask (not shown) and developed, to form photoresist patterns (referred to as “green photoresist patterns”) for green.

As shown in FIG. 1E, protection films 232 are formed on portions of the red photoresist patterns 221. At this time, the portions on which the protection films 232 are formed face portions in which the color filters for red are formed. The protection films 232 may be made of an undyed material.

As shown in FIG. 1F, the substrate 210 is dipped into a green dye, such that the green photoresist patterns 224 are dyed in a green color, to form green color filters. At this time, exposed red photoresist pattern portions 223, the column spacers 225, and the exposed substrate 210 that are not covered by the protection films 232 are dyed. Thus, the exposed red photoresist pattern portions 223 and the column spacers 225 already dyed in the red color are dyed in the green color.

As shown in FIG. 1G, like the red photoresist patterns 221 and the green photoresist patterns 224, after a photoresist film (not shown) is applied on the column spacers 225, the red photoresist pattern portions 223, the protection films 232, the green color filters 224, and the exposed substrate 210, the photoresist film is exposed to light through an optical mask (not shown) and developed, to form photoresist patterns (referred to as “blue photoresist patterns) for blue.

Then, as shown in FIG. 1H, protection films 234 are formed on the green color filters 224. The protection films 234 may be made of an undyed material, like the protection films 232.

As shown in FIG. 1I, the substrate 210 is dipped into a blue dye, such that the blue photoresist patterns 226 are dyed in a blue color, to form blue color filters. At this time, the exposed red photoresist pattern portions 223 and the column spacers 225 that are not covered by the protection films 232 are dyed. Thus, the exposed red photoresist pattern portions 223 and the column spacers 225 are dyed in the three colors of the red, green, and blue. Thereby, the exposed red photoresist pattern portions 223 and the column spacers 225 become black such that the red photoresist pattern portions 223 function as black matrixes.

Next, the protection films 232 and 234 are removed

As shown in FIG. 1J, portions of the column spacers 225 are removed through an etching process, etc. Thus, the bottom portions of the column spacers 225 have a larger diameter than the upper portions of the column spacers 225 such that the bottom portions function to block light as the black matrixes, and the upper portions substantially function as the column spacers.

In the structure, a problem due to the height difference in the portions in which the column spacers 225 are formed may be prevented. The column spacers 225 may be formed as cylinders, and the diameter of the column spacers 225 means the diameter of the cylinder. However, the removing process of the portions of the column spacers 225 may be omitted.

Accordingly, through the above processes, a color filter panel 200 having the red, green, and blue color filters and the black matrixes 223 on the substrate 210 is manufactured.

In the exemplary embodiment, the formation sequence of the color filters is: the red color filters, the green color filters, and the blue color filters, but this may be changed.

In an alternative embodiment, the protection films 232 and 234 are allowed to remain. The protection films may be formed on the blue color filters 226, and the protection films may be made of a material similar to that of the protection films 232 and 234.

In the embodiment, the height of the column spacers 225 may be about 3 μm to about 7 μm, and the thickness of the red, green, and blue color filters 222, 224, and 226 may be about 1 μm to about 2 μm. The thickness of the black matrixes 223 may be also about 1 μm to about 2 μm, and the width of the black matrixes 223 may be about 5 μm to about 25 μm.

Alternatively, the black matrixes 223 on the color filter panel may be not necessary. In this case, the portions of the red photoresist film patterns 223 prevent the dyeing of the red, green, and blue dyes, to prevent the formation of the black matrixes. At this time, the protection films 232 may be adjacent to the protection film 234.

The protection films 232 and 234 may be made of a transparent conductive material, a metal material, or an organic material that is not dyed.

Although not shown, an overcoat may be formed on the color filters 222, 224, and 226, or the black matrixes 223.

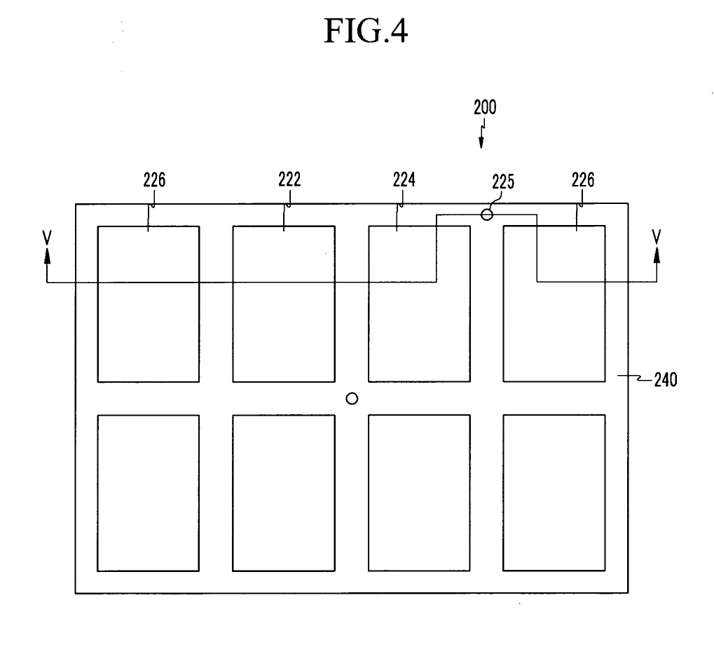

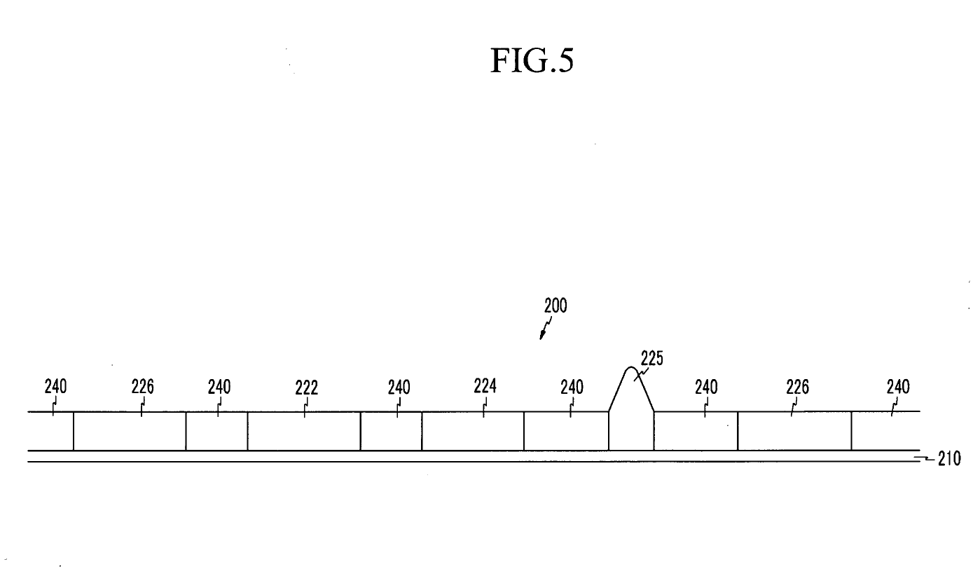

The color filter panel 200 manufactured through the processes is shown in FIGS. 4 and 5.

FIG. 4 is a layout view of the color filter panel according to the first embodiment of the present invention, and FIG. 5 is a sectional view of the color filter panel shown in FIG. 4 taken along the line IV-IV.

### Second Exemplary Embodiment

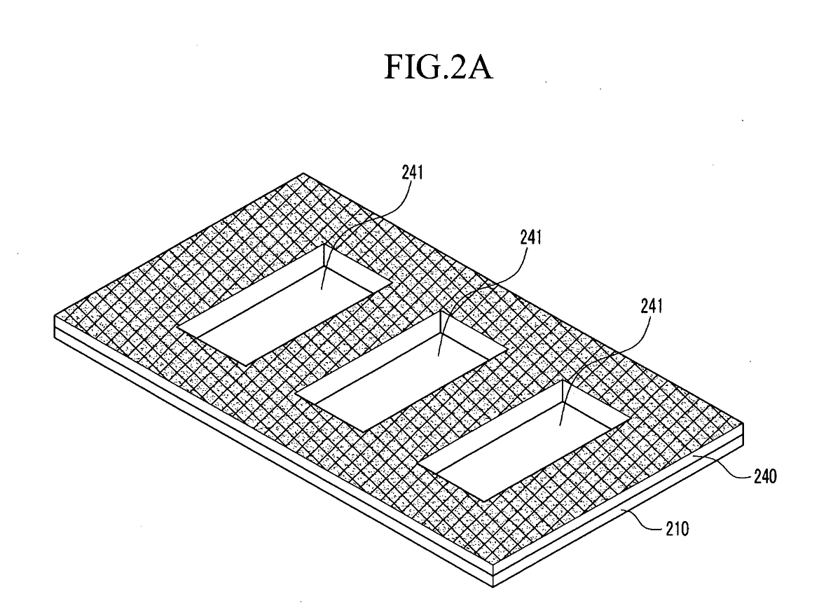

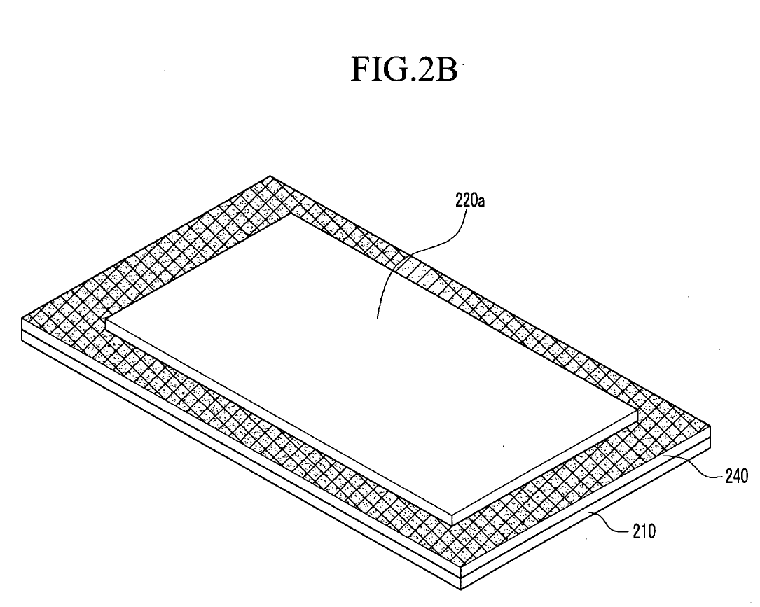

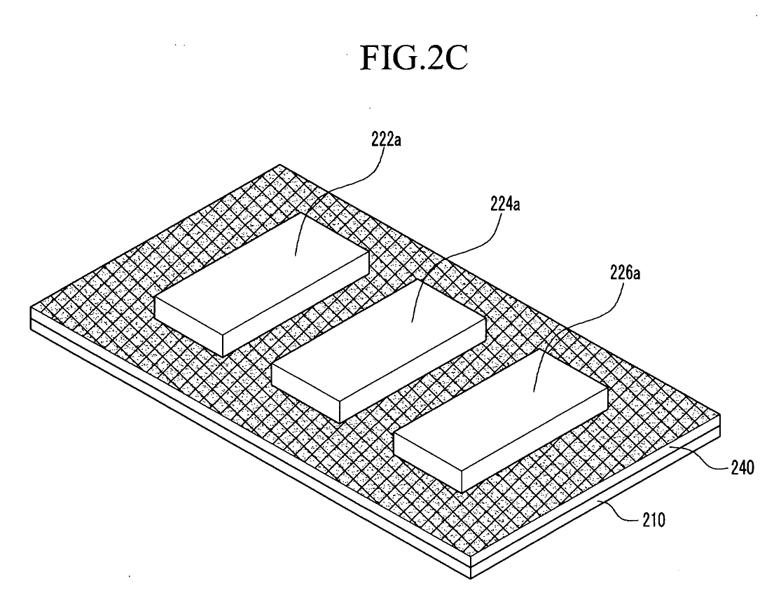

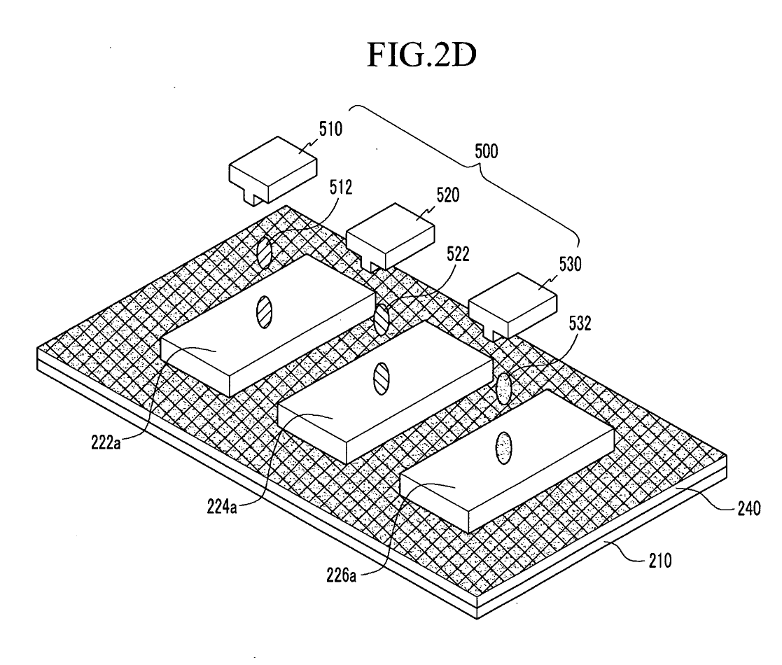

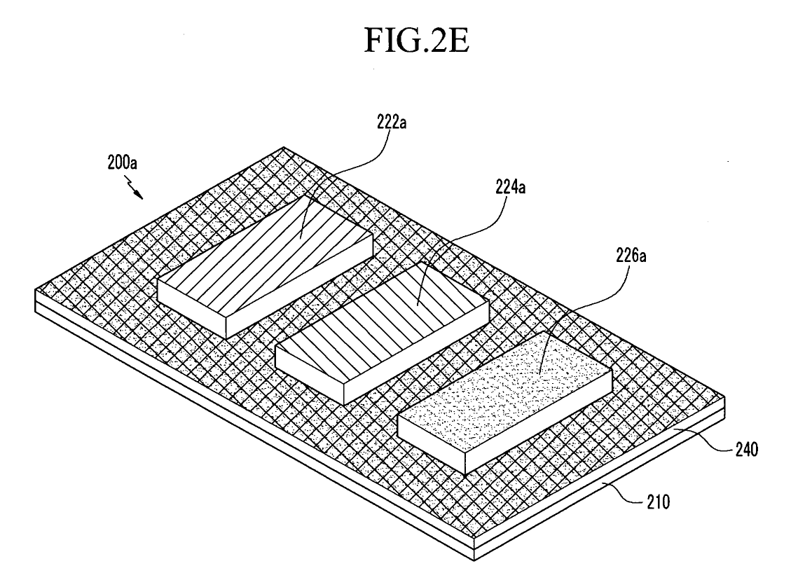

Next, a second exemplary embodiment of the present invention will be described with reference to FIGS. 2A to 2E.

FIGS. 2A to 2E are drawings sequentially showing manufacturing processes of a color filter panel according to a second exemplary embodiment of the present invention.

As shown in FIG. 2A, a black matrix 240 is formed on a transparent insulating substrate 210. The black matrix 240 has a plurality of openings 241.

As shown in FIG. 2B, a photoresist film 220a is applied on the black matrix 220a. The photoresist film 220a may be made of a material of a photosensitive resin and be dyed. As shown in FIG. 2C, the photoresist film 220a is exposed to light through an optical mask (not shown) and developed to form color filter patterns 222a, 224a, and 226a on portions, that is, in the openings 241, in which the black matrix 240 is not formed.

Alternatively, the color filter patterns 222a, 224a, and 226a may be formed in a bottom exposure manner using the black matrix 240 as a light blocking mask, and in this case, the arrangement accuracy of the color filter patterns 222a, 224a, and 226a may be improved. In the bottom exposure manner, the photoresist film 220a may be a negative photoresist film, and a crossing-link reaction occurs in portions exposed to the light such that portions of the photoresist films 220a not exposed to the light may be removed through a development process.

As shown in FIG. 2D, inks of red, green, and blue dyes 512, 522, and 532 are injected in the color filter patterns 222a, 224a, and 226a using an inkjet manner, respectively, to form red, green, and blue color filters.

For the injection of the inks, an inkjet apparatus (not shown) includes one inkjet head body 500 having three inkjet heads 510, 520, and 530 that inject the corresponding color dye, and the inkjet head body 500 may simultaneously inject the red, green, and blue dyes. However, alternatively, the inkjet head 510, 520, and 530 may be formed as three inkjet head bodies, respectively, and thereby the inkjet heads 510, 520, and 530 may individually inject the corresponding color dyes.

Column spacers (not shown) may be formed on the exposed black matrix 240, and the column spacers may be made of a material similar to that of the black matrix 240.

The dyes are injected until the deposited inks have a thickness of about 0.5 μm to about 1.5 μm on the color filter patterns 222a, 224a, and 226a, respectively. The injected inks are absorbed into the color filter patterns 222a, 224a, and 226a as time elapses.

Accordingly, through the above processes, a color filter panel 200a having the red, green, and blue color filters 222a, 224a, and 226a and the black matrix 240 on the substrate 210 is manufactured, as shown in FIG. 2E.

### Third Exemplary Embodiment

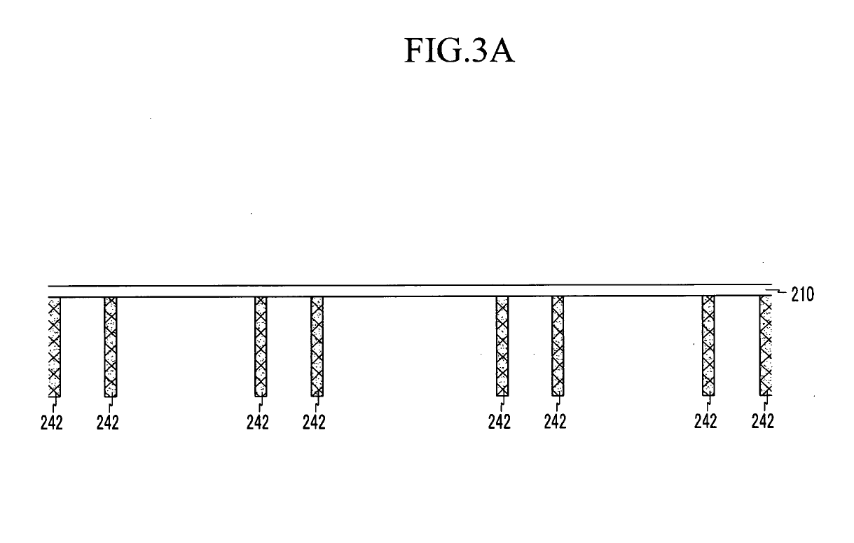

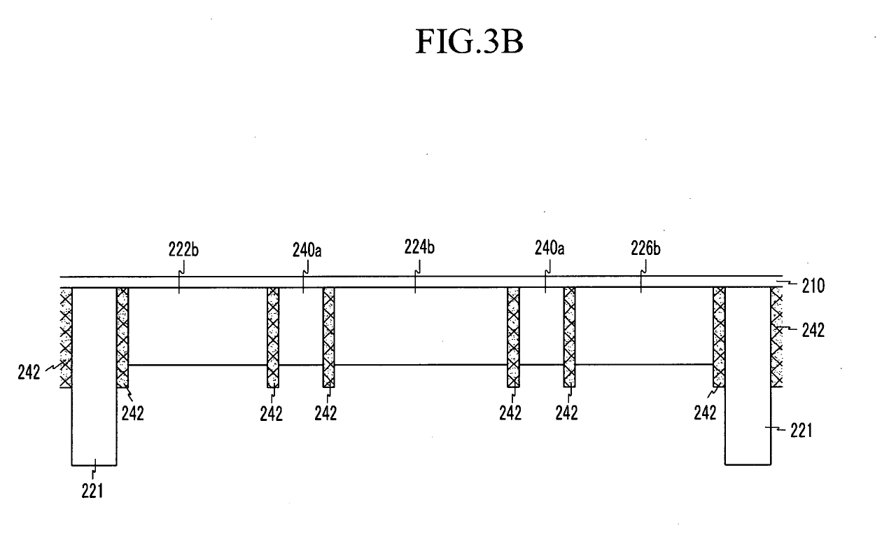

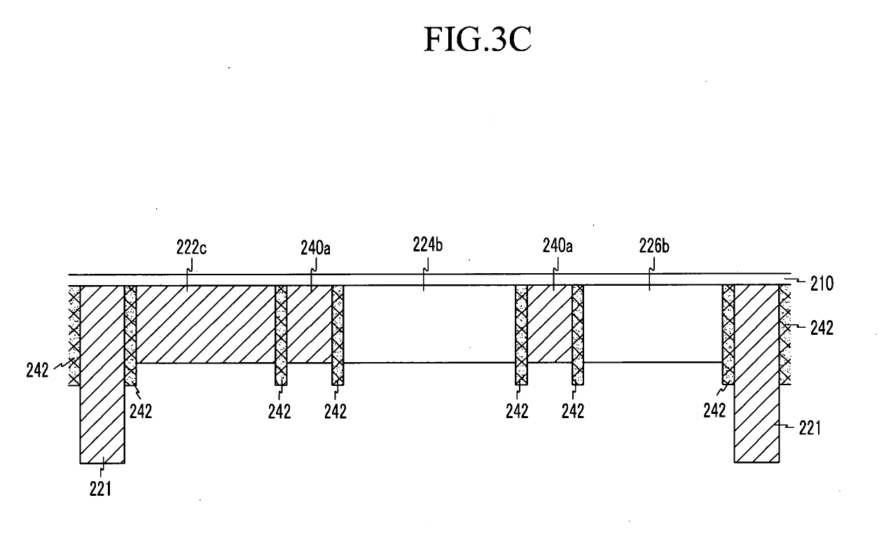

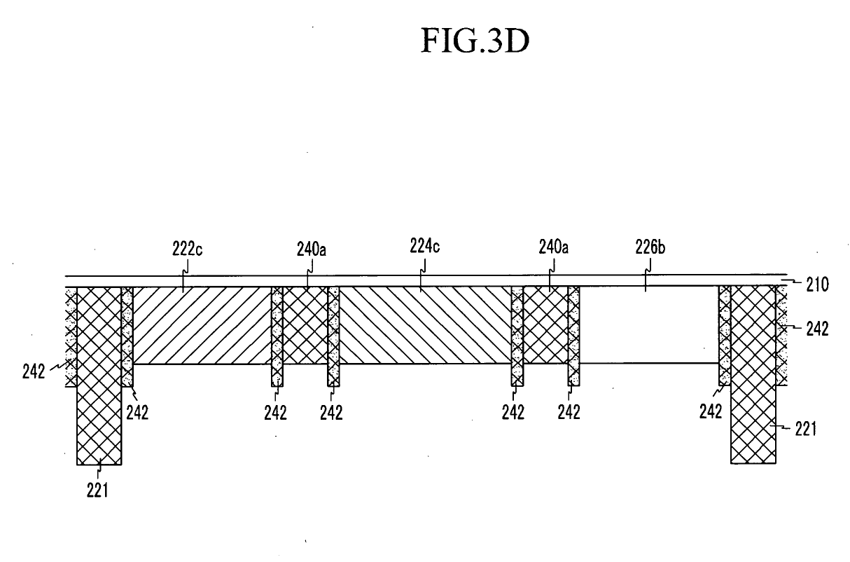

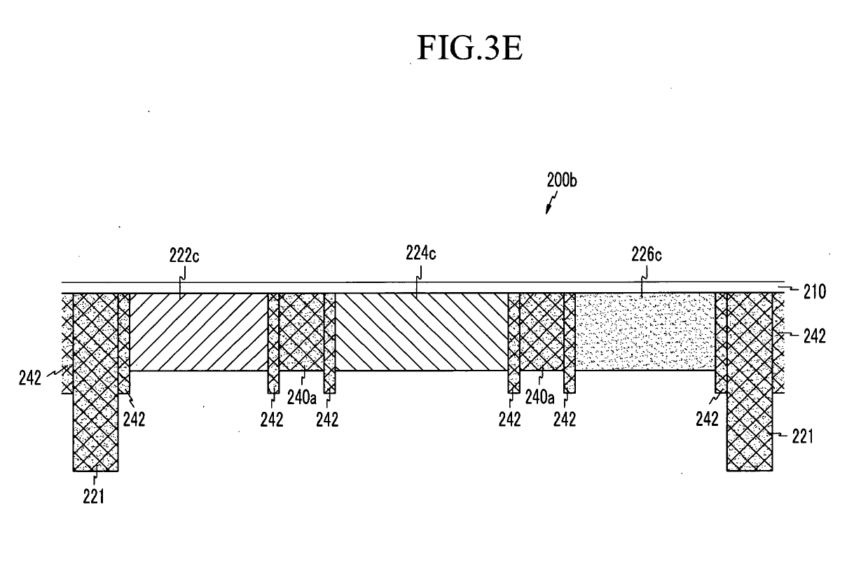

A third exemplary embodiment of the present invention will be described with reference to FIGS. 3A to 3E.

FIGS. 3A to FIG. 3E are drawings sequentially showing manufacturing processes of a color filter panel according to a third exemplary embodiment of the present invention.

As shown in FIG. 3A, sidewalls 242 are formed on a transparent insulating substrate 210. The sidewalls 242 may be made of an opaque material. The substrate 210 may be made of glass, plastic, crystallize quartz, etc.

The sidewalls 242 may be made of an organic material. The sidewalls 242 define boundaries between portions in which color filters are formed and portions in which black matrixes are formed.

The height of the sidewalls 242 may be about 1 μm to about 8 μm.

Next, a photoresist film (not shown) is applied on an insulating substrate 210 having the sidewalls 242. The photoresist film may be made of a material of a photosensitive resin and be dyed. As shown in FIG. 3B, the photoresist film is exposed to light through an optical mask (not shown) and developed to form red, green, and blue color filter region 222b, 224b, and 226b, black matrix regions 240a, and column spacers 221.

The diameter of the column spacers 221 may be smaller than that of the black matrix regions 240a as in the first exemplary embodiment.

However, in an alternative embodiment, the column spacers 221 may be omitted. At this time, a photoresist film having the same thickness as the black matrix regions 240a and made of a photosensitive resin may be formed on portions on which the column spacer regions are omitted. However, the photoresist film may be substituted with a non-photosensitive material.

Next, as shown in FIG. 3C to 3E, red, green, and blue dyes are sequentially injected to the color filter regions 222b, 224b, and 226b, to form red, green, and blue color filters 222c, 224c, and 226c.

At this time, the sidewalls 242 prevent the corresponding color dye from penetrating into the color filter regions 222b, 224b, and 226b for another color.

At this time, the red, green, and blue dyes are also sequentially injected to the column spacers 221 and the black matrix regions 240a such that the column spacers 221 and the black matrix regions 240a are dyed to the opaque black.

Thereby, the black matrix regions 240a become the black matrixes, and the column spacers 221 may block light along with the black matrixes.

Alternatively, the red, green, and blue dyes may be simultaneously injected to the corresponding color filter regions 222b, 224b, and 226b using an inject head having three injection nozzles that inject the red, green, and blue dyes, respectively, to form the color filters 222c, 224c, and 226c.

Accordingly, through the above processes, color filter panel 200b having the red, green, and blue color filters 222c, 224c, and 226c and the black matrixes 240b on the substrate 210 is manufactured.

When the color filters are formed by injection of the color dyes, the contrast ratio of a display device is improved and manufacturing processes of the color filters are simplified, and therefore the manufacturing cost is reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A color filter panel comprising:
a substrate;
a plurality of color filters formed on the substrate and dyed by at least two color dyes to represent at least two colors; and
a column spacer made of the same material as the color filters.

2. The color filter panel of claim 1, further comprising a black matrix formed between the color filters representing the different colors and repeatedly dyed by the two color dyes.

3. The color filter panel of claim 2, wherein the color filters are dyed using an inkjet method or a dipping method.

4. The color filter panel of claim 2, wherein the column spacer is repeatedly dyed by the two color dyes.

5. A color filter panel comprising:
a substrate;
a plurality of sidewalls formed on the substrate;
a plurality of black matrixes formed between the sidewalls; and
a plurality of color filters formed between the black matrixes and dyed by at least two color dyes to represent at least two colors.

6. The color filter panel of claim 5, further comprising a column spacer between the sidewalls.

7. The color filter panel of claim 6, wherein the column spacer is made of the same material as the color filters.

8. The color filter panel of claim 7, wherein the column spacer is repeatedly dyed by the two color dyes.

9. The color filter panel of claim 5, wherein the black matrixes are repeatedly dyed by the two color dyes.

10. The color filter panel of claim 5, wherein the color filters are dyed using an inkjet method.

11. The color filter panel of claim 5, wherein the sidewalls are narrower than the black matrixes.

12. A method of manufacturing a color filter panel, comprising:
forming a first photoresist film on a substrate;
patterning the first photoresist film to form a plurality of first color filter regions;
dyeing the first color filter regions with a first dye;
forming a second photoresist film on the substrate and the first color filter regions;
patterning the second photoresist film to form a plurality of second filter regions;
dyeing the second color filter regions with a second dye;
forming a second photoresist film on the substrate and the first color filter regions;
patterning the second photoresist film to form a plurality of second color filter regions;
forming a first protection layer on portions of the first color filter regions;
dyeing the second color filter regions and black matrix portions not covered with the first protection layer with a second dye;
forming a third photoresist film on the substrate, the first and second color filter regions, and the first protection layer;
patterning the third photoresist film to form a plurality of third color filter regions;
forming a second protection layer on portions of the second color filter regions; and
dyeing the third color filter regions and the black matrix portions with a third dye.

13. The manufacturing method of claim 12, wherein the formation of the first color filter regions comprises forming a column spacer.

14. The manufacturing method of claim 13, wherein the color filter regions and the column spacer are formed using an optical mask having a translucent area.

15. The manufacturing method of claim 12, wherein the first to third dyes have different colors from each other, and the colors are red, green, and blue.

16. The manufacturing method of claim 12, wherein the black matrix portions function as black matrixes.

17. The manufacturing method of claim 12, further comprising removing a portion of the column spacer.

18. A method of manufacturing a color filter panel, comprising:
forming a black matrix having a plurality of openings;
forming a photoresist film on the black matrix;
patterning the photoresist film to form a plurality of color filter patterns; and
dyeing the color filter patterns with a predetermined color.

19. The manufacturing method of claim 18, wherein the color filter patterns are formed on substantially the same positions as the openings.

20. The manufacturing method of claim 18, wherein the color filter patterns are dyed with one of a plurality of colors.

21. The manufacturing method of claim 20, wherein the plurality of colors are red, green, and blue.

22. The manufacturing method of claim 21, wherein the color filter patterns are dyed by injection of inks.

23. The manufacturing method of claim 22, wherein the inks are injected until the ink deposition thickness on the color filter patterns is about 0.5 μm to 1.5 μm.

24. A method of manufacturing method a color filter panel, comprising:
forming a plurality of sidewalls on a substrate;
forming a photoresist film on the substrate;
patterning the photoresist film to form a plurality of color filter regions and a plurality of black matrix regions; and
dyeing the color filter regions and the black matrix regions with a predetermined color to form a plurality of color filters and a plurality of black matrixes.

25. The manufacturing method of claim 24, wherein the color filter regions have first to third regions.

26. The manufacturing method of claim 25, wherein the first to third regions are dyed with different colors.

27. The manufacturing method of claim 26, wherein the first to third regions are dyed with one of red, green, and blue colors.

28. The manufacturing method of claim 27, wherein the black matrix regions are dyed with the red, green, and blue colors.

29. The manufacturing method of claim 28, wherein the black matrix regions are formed between the sidewalls.

30. The manufacturing method of claim 24, wherein the formation of the color filter regions and the black matrix regions comprises forming a column spacer.

31. The manufacturing method of claim 30, wherein the column spacer is formed between the sidewalls.

32. The manufacturing method of claim 24, wherein the sidewalls narrower than the black matrixes.
